(19) United States
(12) Patent Application Publication
(10) Pub. No.: US 2011/0025175 A1
(43) Pub. Date: Feb. 3, 2011

(54) LOCK FOR A VENDING MACHINE, CABINET, OR THE LIKE

(76) Inventor: Dieter Ramsauer, Schwelm (DE)

Correspondence Address: FROMMER LAWRENCE & HAUG, 745 FIFTH AVENUE- 10TH FL., NEW YORK, NY, 10151, US

(21) Appl. No.: 12/746,210

(22) PCT Filed: Dec. 5, 2008
(86) PCT No.: PCT/EP08/10317

§ 371 Date: Jun. 23, 2010

(30) Foreign Application Priority Data
Dec. 7, 2007 (DE) 20 2007 017 068.8

(51) Int. Cl. E05B 1/00; A47B 96/00; E05B 5/00

(52) U.S. Cl. 312/215; 312/326

(57) ABSTRACT

A closure for a vending machine, cabinet, or the like including a housing, an elongated rod supported in the housing so as to be rotatable and axially displaceable via a handle. The rod can be received in a rod receptacle, so that the rod can be freely slid axially in and out of this rod receptacle in a releasing rotational position, but cannot be slid out in a locking rotational position. The handle is tiltable around a first axis and is rotatable around a second axis perpendicular to the first axis. A connection joint arm is arranged between the supported ends of the handle and the rod, the two articulation axes of the connection joint arm being arranged parallel to the bearing axis of the handle such that the rod is displaced axially when the handle is tilted around the bearing axis of the handle.

The present application claims priority from PCT Patent Application No. PCT/EP2008/010317 filed on Dec. 5, 2008, which claims priority from German Patent Application No. DE 20 2007 017 068.8 filed on Dec. 7, 2007, the disclosure of which is incorporated herein by reference in its entirety.

### BACKGROUND OF THE INVENTION

1. Field of the Invention

The invention is directed to a closure for a vending machine or the like comprising a housing which can be secured in a movable thin wall such as a sheet-metal door leaf, an elongated rod being supported in the housing so as to be rotatable and axially displaceable in a limited manner by means of a handle, which rod can be received in such a way in a rod receptacle formed by or carried by a stationary frame or wall that the rod can be freely slid axially in and out of the rod receptacle in a rotational position (releasing position), but is prevented from being slid out in another rotational position (locking position).

2. Description of Related Art

A closure of the type mentioned above is already known from U.S. Pat. No. 5,467,619.

In the prior art, the entire closure must be moved by means of a cylinder key, which can lead to problems in case of stiff closures.

### SUMMARY OF THE INVENTION

It is the object of the invention to provide an alternative to the known closure which can be operated easily even in case of stiffness.

The above-stated object is met in that the handle is supported in the housing so as to be tiltable around an axis extending parallel to the plane of the movable wall and, at the same time, so as to be swivelable around an axis extending perpendicular to the plane of the wall, and in that a connection joint arm is arranged between the supported ends of the handle and rod, the two articulation axes of the connection joint arm being arranged parallel to the bearing axis of the handle and at a distance from one another such that the rod is displaced axially when the handle is tilted around the bearing axis.

A tilting handle is used instead of a key-shaped handle so that actuation is generally easier even in case of stiff closures.

According to a further development of the invention, the housing has the shape of a trough into which the handle can be tilted and locked in the tilted-in position.

According to another embodiment form of the invention, the handle can be locked by means of a cylinder lock which is movable centrally or which is arranged at the free end of the handle or in the trough.

According to another embodiment form, a cylindrical cavity is provided in the area of the bearing support for the handle, and a cylindrical bearing piece is received in this cylindrical cavity so as to be rotatable but fixed with respect to axial displacement, the tilting bearing support for the handle being formed in this cylindrical bearing piece.

According to another embodiment form, the trough has parts which penetrate the plane of the wall toward the inside, and hook devices and/or clip or wedge devices which engage behind the back of the wall project from these parts.

The rod receptacle makes it possible for the rod to be slid into the receptacle axially also in the locking position of the rod, so that a key is not needed to close the door and, therefore, there is also no need for a key to be actuated.

The closing mechanism is further facilitated according to another embodiment form by providing a return spring or torsion spring which forces the handle into the rotational position (locking position) in which it can be tilted in.

The invention is also directed to a closure for a vending machine, cabinet or the like comprising a housing which can be secured in a movable thin wall such as a sheet-metal door leaf, an elongated rod or shaft being supported in the housing so as to be rotatable and axially displaceable in a limited manner by means of a handle, this rod having at its free end a sash-type fastener which can be received at or in a rod receptacle or sash-type fastener receptacle (e.g., back-engagement surface for the sash-type fastener) formed by or carried by a stationary frame or wall, such as a door frame, such that the sash-type fastener (rotary latch) and, therefore, the rod can be freely slid axially in and out of the latch receptacle or rod receptacle in a rotational position (releasing position), but is prevented from being slid out in another rotational position (locking position).

In this case, the solution consists in that the handle is supported in the housing so as to be tiltable around an axis extending parallel to the plane of the movable wall and, at the same time, so as to be rotatable around an axis extending perpendicular to the plane of the movable wall, and in that a connection joint arm is arranged between the supported ends of the handle and rod, the two articulation axes of the connection joint arm being arranged parallel to the bearing axis of the handle at a distance from one another such that the rod is displaced axially when the handle is tilted around the bearing axis of the handle.

According to a further development, the closure is characterized in that the handle is supported in such a way that the three axes extending parallel to the wall lie on a line, particularly on the axis of the shaft (dead center position) in the tilted-in position of the handle.

According to another further development, the closure is characterized in that the housing has the shape of a trough into which the handle can be tilted and locked in its dead center position in the tilted-in position.

### BRIEF DESCRIPTION OF THE DRAWINGS

FIG. 1A shows a perspective view of the closure in the closed position;

FIG. 1B shows an enlarged view of the upper end of the closure according to FIG. 1A after removal of the key;

FIG. 1C shows a sectional view through the upper end of the closure according to FIG. 1A in the tilted-in position;

FIG. 2A shows a perspective view through the upper end of the closure in the tilted-up position;

FIG. 2B shows a sectional view through the arrangement according to FIG. 2A;

FIG. 2C shows another perspective view of the upper end of the closure in the tilted-out position;

FIG. 3A shows a view similar to FIG. 1A showing the entire closure in the tilted-out, rotated position;

FIG. 3B shows an enlarged view of the upper end of the closure according to FIG. 3A in the open position;

FIG. 3C shows a sectional view through the arrangement according to FIG. 3B;

FIG. 4 shows an exploded view of the individual parts of the closure according to FIGS. 1A to 3C;

FIG. 5 shows the closure from FIG. 1 in the partially assembled state without the housing;

FIG. 6 shows the arrangement according to FIG. 5, but with the housing indicated by phantom lines;

FIG. 7A shows another embodiment form with tilted-in lever in the closed state with fastened rotary latch in a sectional view;

FIG. 7B shows another embodiment form with tilted-out lever and, therefore, released rotary latch;

FIG. 7C shows another embodiment form with tilted-out lever which is rotated by 90 degrees and, therefore, a released closure; and

FIGS. 7D, 7E, and 7F show a perspective view of the closure position from FIGS. 7C, 7B, and 7A.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

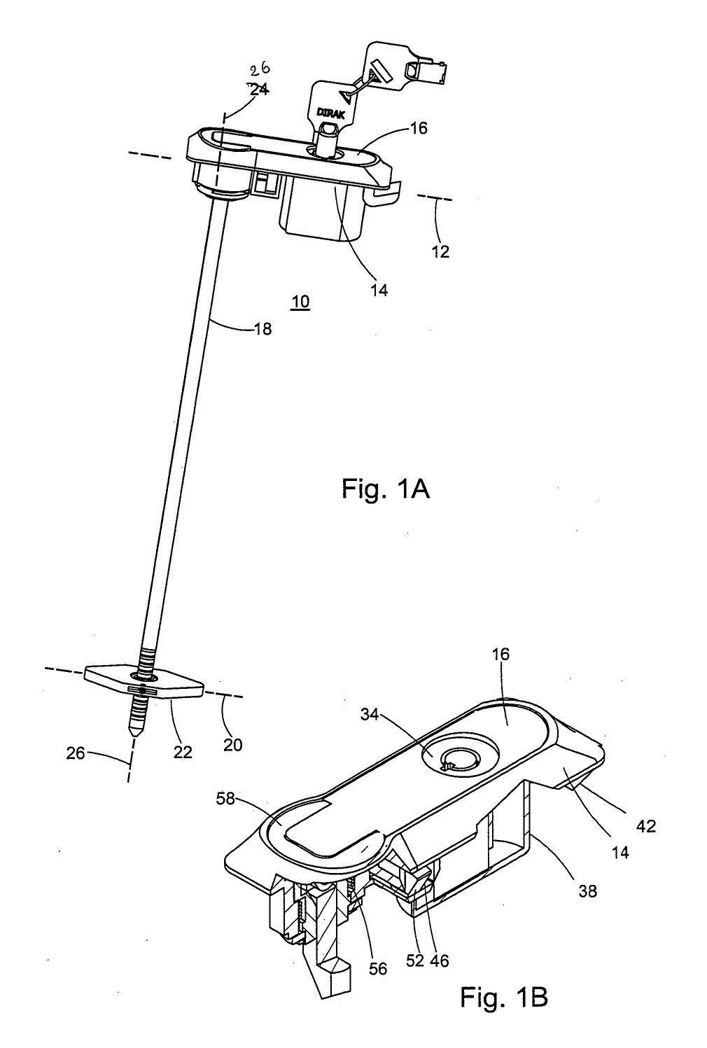

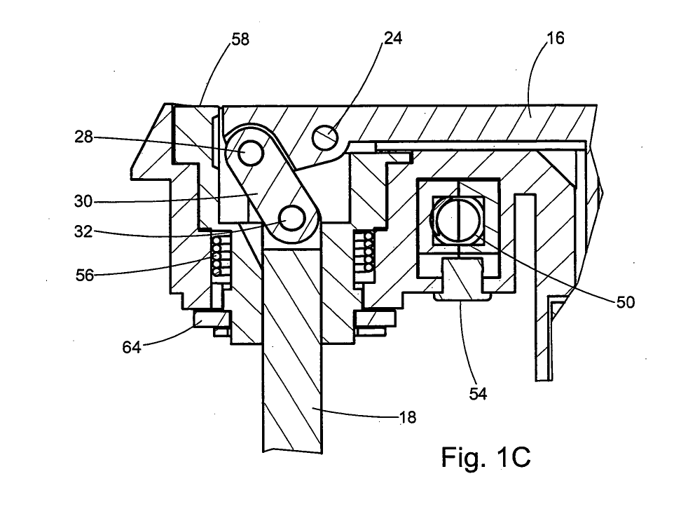

FIG. 1 shows a closure 10 for a vending machine or cabinet or the like comprising a housing 14 which can be secured in a movable wall, particularly a thin wall 12 such as a sheet-metal door leaf, an elongated rod 18 which is rotatable by means of a handle 16 being supported in the housing 14 so as to be rotatable and axially displaceable in a limited manner. The rod 18 can be received in such a way in a rod receptacle 22 formed by or carried by a stationary frame or wall 20 that the rod can be freely slid axially in and out of the rod receptacle 22 in a rotational position (releasing position), but is prevented from being slid out in another rotational position (locking position) shown in FIG. 1A. The handle 16 is supported in the housing 14 so as to be tiltable around an axis 24 extending parallel to the plane of the movable wall 12 and, at the same time, so as to be rotatable around an axis 26 extending perpendicular to the plane of the movable wall 12. A connection joint arm 30 is arranged between the supported ends of the handle 16 and rod 18 (see FIG. 1C), the two articulation axes 28, 32 of the connection joint arm 30 being arranged parallel to the bearing axis 24 of the handle 16 and at a distance from one another such that the rod 18 is displaced axially when the handle 16 is tilted around the bearing axis 24.

The housing 14 has the shape of a trough into which the handle 16 can be tilted and locked in a tilted-in position. A cylinder lock 34, for example, which is fastened in the hand lever 16 is used for locking and engages behind a rear part 38 of the housing 14 by its sash-type fastener or latch 36 in such a way that the handle 16 cannot be tilted out of the trough of the housing 14 in this locking position of the cylinder 34.

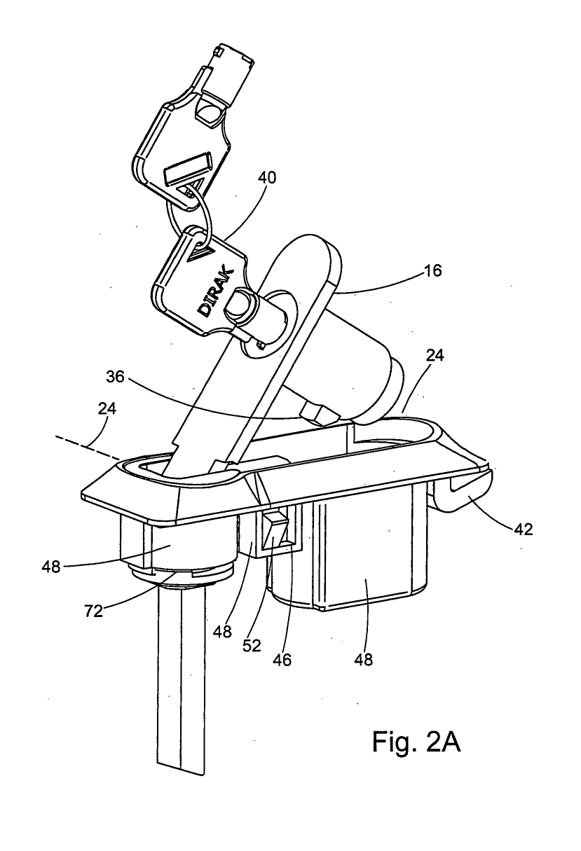

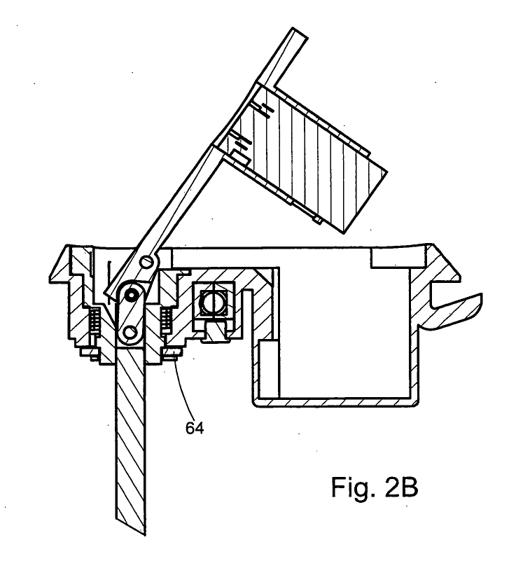

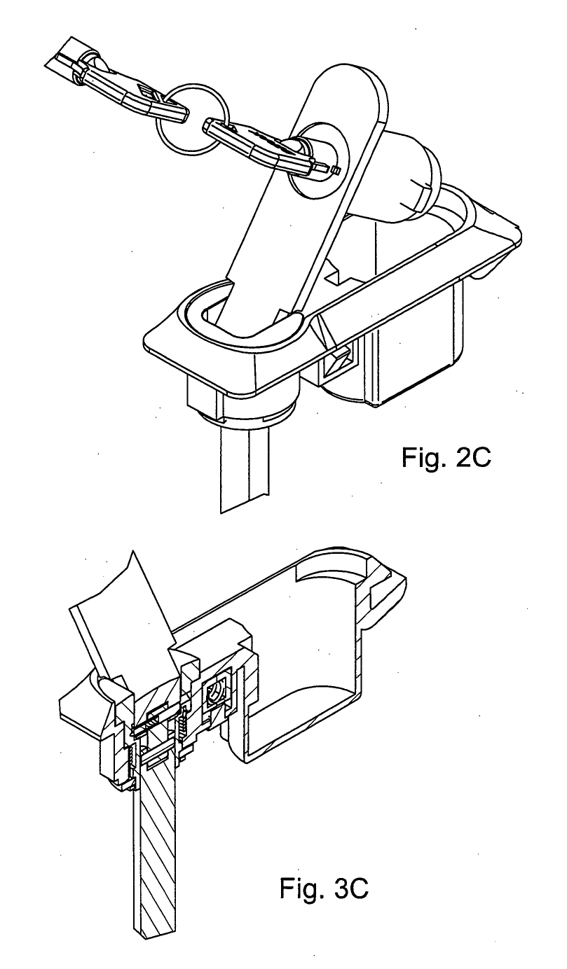

The handle 16 cannot be tilted out of the trough 14 until the sash-type fastener 40 of the cylinder lock 34 has been swiveled (e.g., by 90 degrees) with the key 40 as is shown in FIG. 2A.

As is shown in FIGS. 1A and 1B, the handle 16 can be locked by means of a cylinder lock which is arranged centrally thereon; but an arrangement in which the cylinder lock is arranged at the end of the hand lever 16 or in the trough area is also possible.

The trough 14 has parts 42, 44, 46, 48 which penetrate through the plane of the wall 12 toward the inner side, and hooks 42 and/or clip or wedge devices 46 which engage behind the back of the wall 12 project from or are formed by these parts 42, 44, 46, 48. Accordingly, the clip device 46 forms a spring-loaded (50) slide 46 with a wedge-shaped clamping shape as is described, for example, in WO 2005/071198 A1 for a hinge.

The slide 52 which is installed on both sides can also be drawn back by means of a releasing pin or releasing screw 54 for disassembling the closure.

As in the prior art, the rod receptacle 22 is constructed in such a way that it makes it possible to slide the rod into the receptacle 22 also in the locking position of the rod, but does not allow it to be pulled out which can be made possible, for example, by spring devices in the receptacle 22 as in the prior art described in U.S. Pat. No. 5,467,619.

The embodiment form shown in FIG. 1B has a return spring or torsion spring 56 which forces the handle 16, and therefore the rod 18, into the rotational position (e.g., the locking position) in which it can be tilted in.

The tiltability of the hand lever 16 around axis 24 and the rotatability of the hand lever 16 around axis 26 is achieved by providing a rotatable bearing part 58 (i.e., receptacles 60 for shaft journals 62). The bearing part 58 is rotatably received in the housing 14 on one side and is prevented from slipping out at the top by a locking disk 64. The bearing part 58 forms an axially displaceable and rotatable bearing support for the rod 18 so that the bearing part 58 is connected to the rod 18 so as to be fixed with respect to rotation relative to it when rotated by the tilting handle arrangement 16. In this respect, reference is had to FIG. 1C which is a sectional view through the arrangement.

The arrangement operates in the following manner:

After the cylinder lock with its latch 36 has been rotated by means of a key 40 in such a way that the latch 36 has reached a releasing position, as is shown in FIG. 2A, the hand lever or handle 16 can be tilted out around its axis 24. This position is shown in FIG. 2A.

FIG. 2B shows this situation in more detail in a sectional view.

FIG. 2C shows how the cylinder lock with its latch 36 reaches through the receptacle area of the trough to make it possible to tilt the latch through the trough.

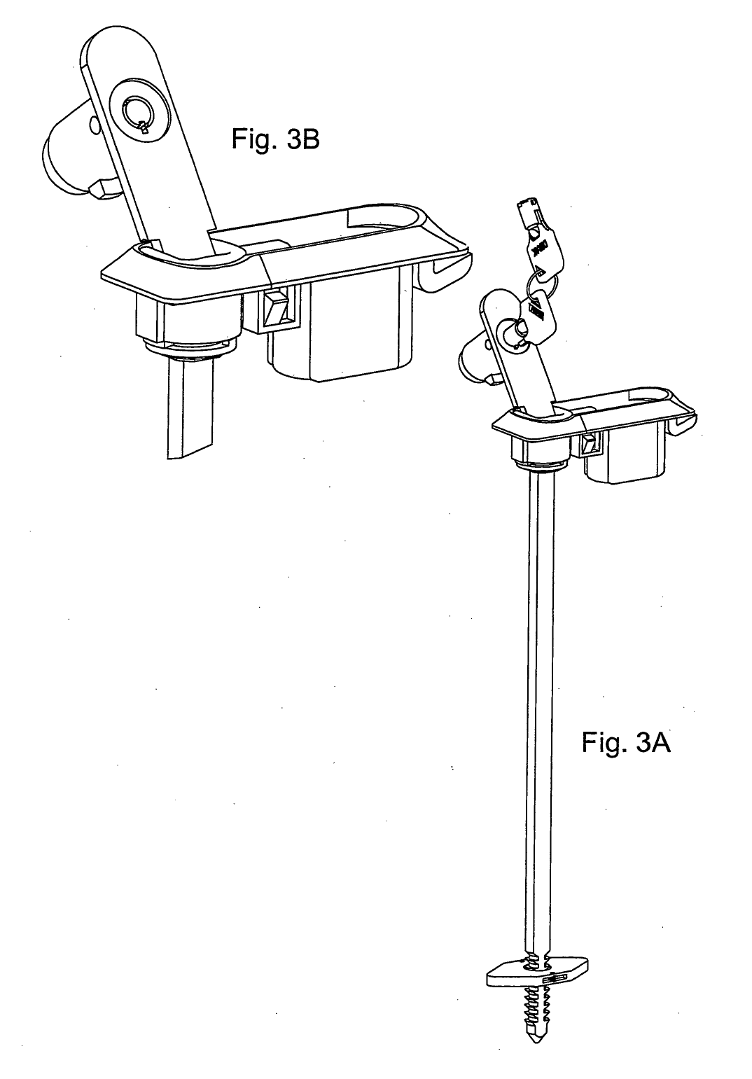

The hand lever can now be rotated out of this tilted-out position, namely, into the position shown in FIGS. 3A, 3B and 3C FIG. 3C also clearly shows the arrangement of the different axes.

When the hand lever is subsequently released, it is rotated back into the tilt-in position by the coil spring 56 so that pressure need only be applied to the tilting lever 16 to lock it again by rotating and removing the key.

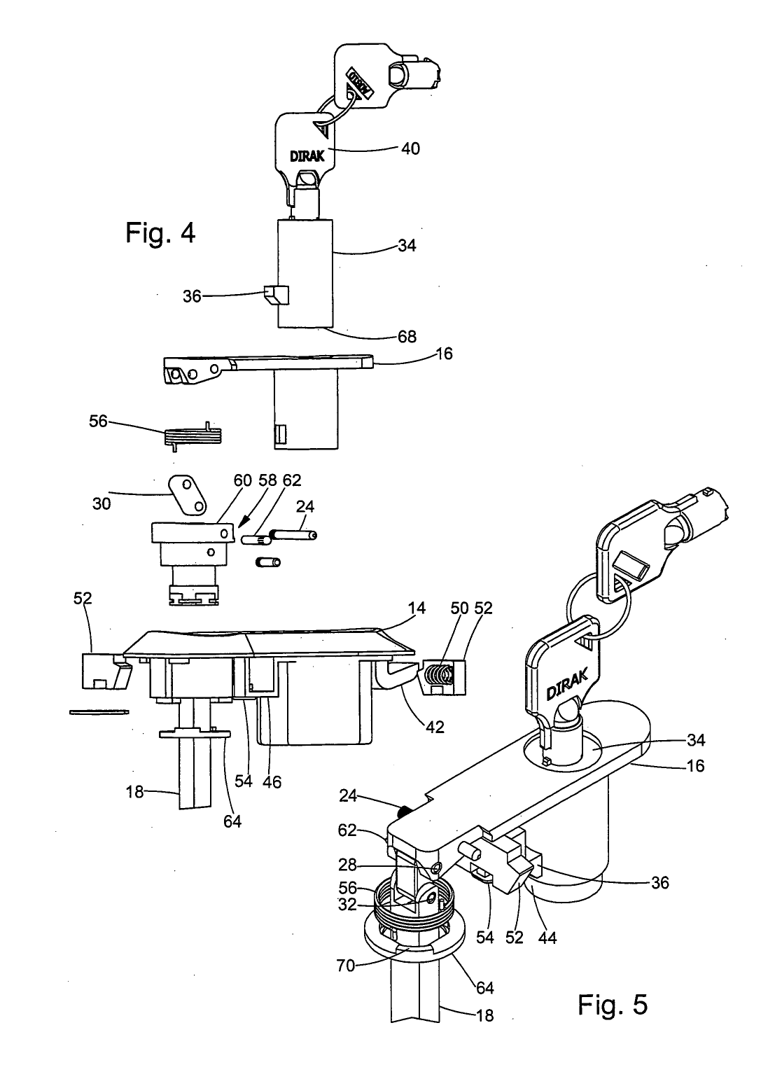

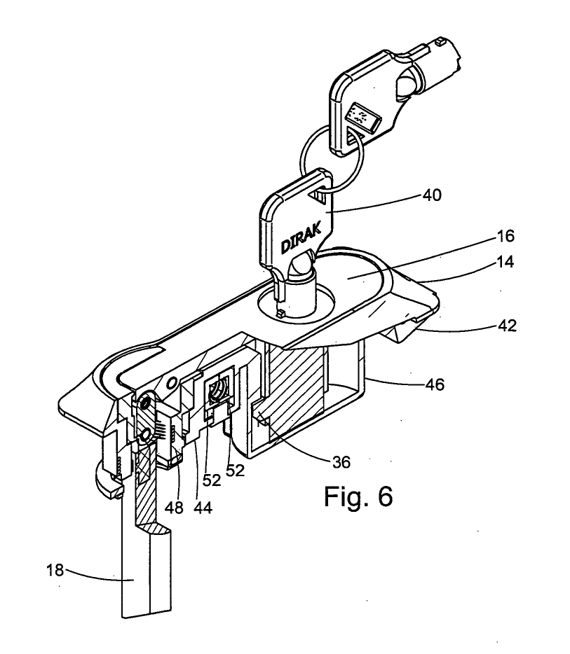

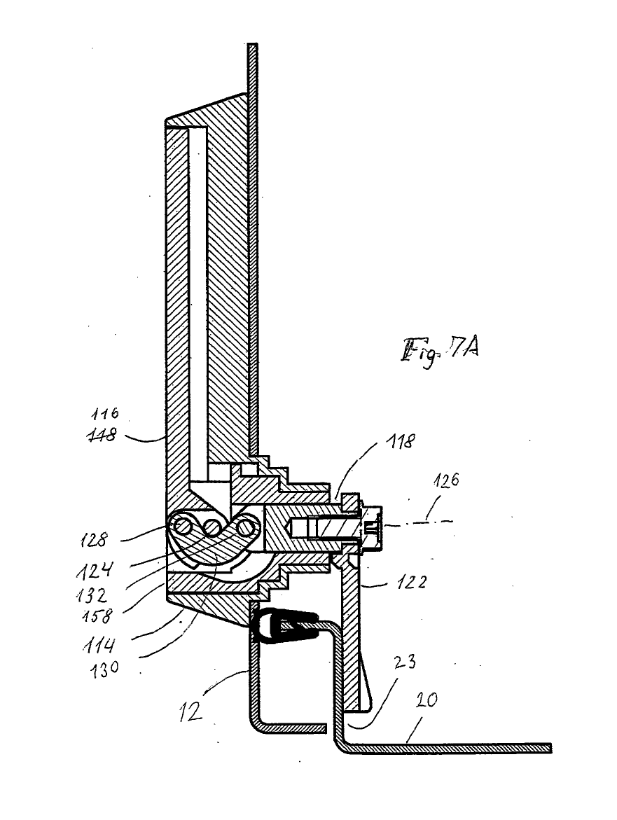

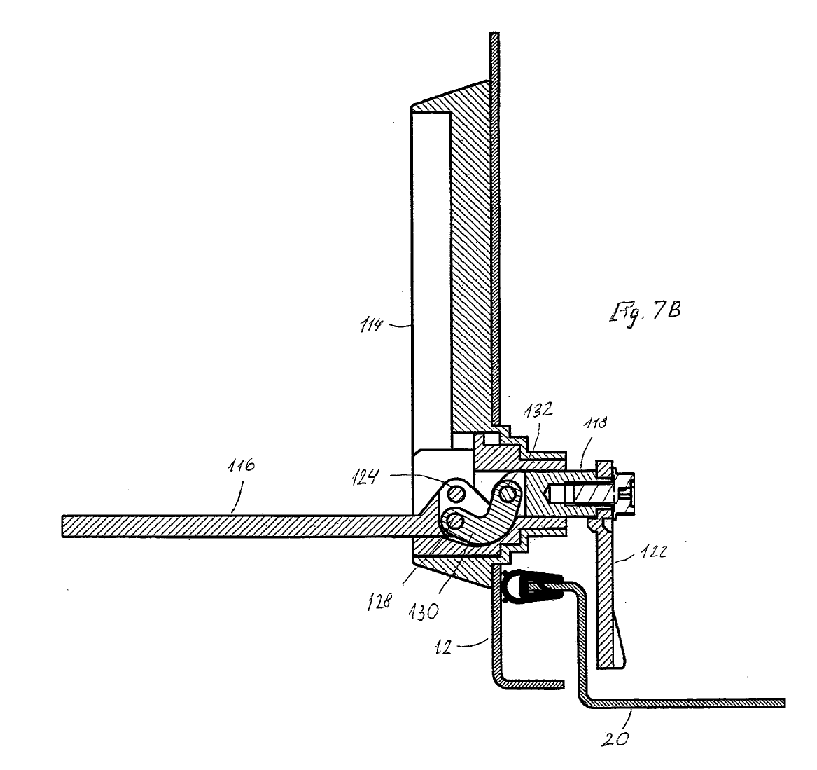

FIG. 4 is an exploded view of the different parts which have already been mentioned. It should also be noted that the sash-type fastener 36 is fastened to the locking cylinder core 68 by screw 66. Accordingly, as is shown in FIG. 4 and FIG. 5, the bearing journals 62 mentioned above are formed by small screws which can be screwed laterally into the end of the hand lever 16.

Further, the locking disk 64 receives an end of the torsion spring 56 when the other end is secured in the housing 14, which is not shown.

Further, the locking disk 64 receives one end of the torsion spring 56 when the other end is secured in the housing 14, not shown.

The locking disk 64 is connected to the rectangular rod 18 so as to be rigid against rotation, but axially displaceable, relative to it. The locking disk 64 also makes it possible to limit the rotational path of the rod 18 and, therefore, of the handle 16 through projections 70 which cooperate with stop surfaces 72 at the housing 14, 48.

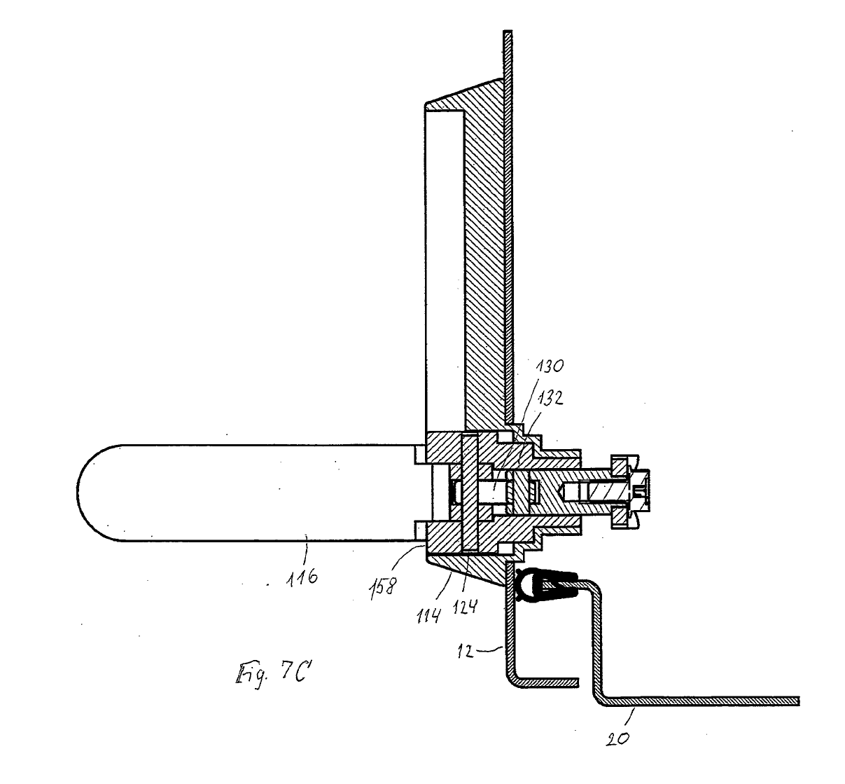

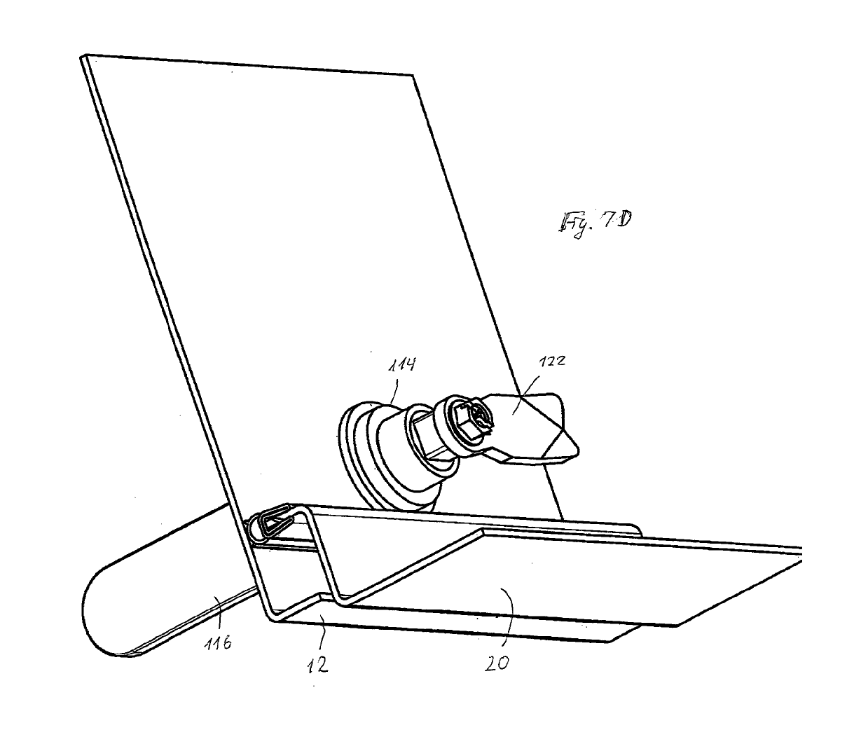

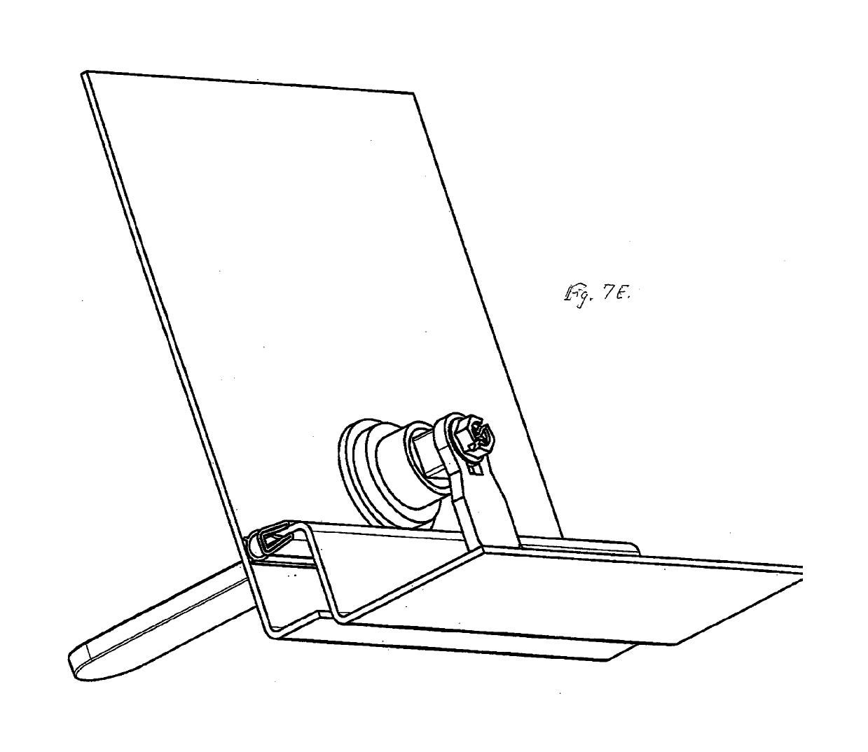

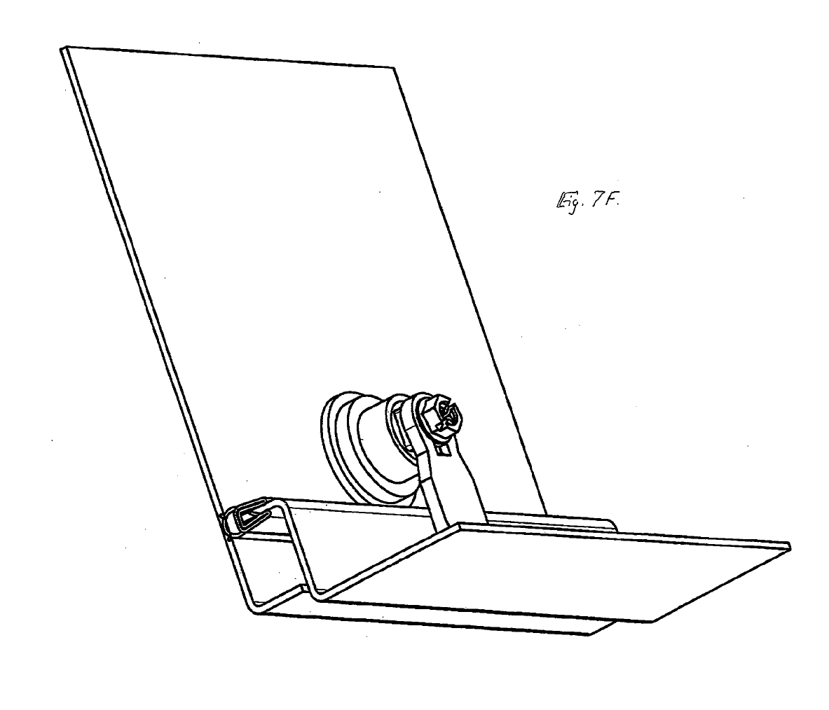

FIG. 7A is a sectional view showing another embodiment form with tilted-in lever in the closed position with fastened rotary latch.

FIG. 7B shows the tilted-out lever and, therefore, the disengaged rotary latch.

FIG. 7C shows the tilted-out lever which is rotated by 90 degrees so that the closure is released.

FIGS. 7D, 7E and 7F show a perspective view of the closure position from FIGS. 7C, 7B and 7A.

FIGS. 7A to 7F show a closure 110 for a vending machine, cabinet or the like comprising a housing 114 which can be secured in a movable thin wall 12, such as a sheet-metal door leaf, an elongated bar 18 particularly in the form of a shaft 118 being supported in the housing 114 so as to be rotatable and axially displaceable in a limited manner by means of handle 116. At its free end, the bar 118 has a sash-type fastener or rotary latch 122 which can be received in such a way at or in a rod receptacle or sash-type fastener receptacle (e.g., back-engagement surface 23 for the sash-type fastener 122) formed by or carried by a stationary frame or wall 20, such as a door frame, that the rod (118) can be freely slid axially in and out of the rod receptacle (23, 122) in a rotational position (releasing position), but is prevented from being slid out in another rotational position (locking position).

This is accomplished in that the handle 116 is supported in the housing 114 so as to be tiltable around an axis 124 extending parallel to the plane of the movable wall 12 and, at the same time, so as to be rotatable around an axis 126 extending perpendicular to the plane of the movable wall 12, and in that a connection joint arm 130 is arranged between the supported ends of handle 116 and rod 118, the two articulation axes (128 and 132) of the connection joint arm 130 being arranged parallel to the bearing axis 124 of the handle 116 at a distance from one another such that the rod 118 is displaced axially when the handle 116 is tilted around the bearing axis 124 of the handle 116.

The handle 116 is supported in such a way that the three axes 128, 124, 132 extending parallel to the wall 12 lie on a line, particularly on the axis 126 of the shaft 118 (i.e., a dead center position) in the tilted-in position of the handle 116.

Further, the closure is constructed in such a way that the housing 114 has the shape of a trough into which the handle 116 can be tilted and locked in its dead center position in the tilted-in position either by the dead center position as such, in which no torque acts on the lever in the tilting direction, or additionally by a lock, not shown.

### COMMERCIAL APPLICABILITY

The invention is commercially applicable in cabinet construction.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### REFERENCE NUMBERS

10 closure
12 movable (thin) wall, door leaf
14 housing
16 handle
18 rod
20 stationary wall, (door) frame
22 rod receptacle
24 tilting axis
26 axis of rotation
28 articulation axis
30 connection joint arm
32 articulation axis
34 cylinder lock
36 sash-type fastener, latch
38 rear part
40 key
42 hook device
44 clip device
46 penetrating part
48 penetrating part
50 spring
52 wedge-shaped slide
54 releasing pin, releasing screw
56 torsion spring
58 bearing part
60 bearing receptacles
62 bearing journals
64 locking disk
66 screw
68 cylinder lock core
70 projection
72 stop

1. A closure for a vending machine, cabinet, or the like comprising:
a housing which can be secured in a movable thin wall;
an elongated rod being supported in the housing so as to be rotatable and axially displaceable in a limited manner by means of a handle;
wherein the rod is received in a rod receptacle formed by or carried by a stationary frame or wall in such a way that the rod can be freely slid axially in and out of this rod receptacle in a releasing rotational position, but is prevented from being slid out in a locking rotational position;
wherein the handle is supported in the housing so as to be tiltable around a bearing axis extending parallel to the plane of the movable wall and, at the same time, is supported in the housing so as to be rotatable around an axis extending perpendicular to the plane of the movable wall;
wherein a connection joint arm is arranged between supported ends of the handle and the rod; and
wherein two articulation axes of the connection joint arm are arranged parallel to the bearing axis of the handle at a distance from one another such that the rod is displaced axially when the handle is tilted around the bearing axis of the handle.

2. The closure according to claim 1;
wherein the housing has a shape of a trough into which the handle can be folded and locked in a folded-in position.

3. The closure according to claim 2;
wherein the handle can be locked by means of a cylinder lock which is arranged centrally with respect to or at the free end of the handle or in the trough.

4. The closure according to claim 2;
wherein a cylindrical cavity is formed in the area of the bearing support for the handle;
wherein a cylindrical bearing piece is received in the cylindrical cavity so as to be rotatable but fixed with respect to axial displacement; and
wherein a tilting bearing support forming the bearing axis of the handle is formed in the cylindrical bearing piece).

5. The closure according to claim 1;
wherein the trough has parts which penetrate the plane of the wall toward the inside; and
wherein hook devices, and/or clip or wedge devices engage behind the back of the wall and project from the penetrating parts.

6. The closure according to claim 1;
wherein the rod receptacle also makes it possible for the rod to be slid in axially in the locking position of the rod.

7. The closure according to claim 1;
wherein a return spring or torsion spring forces the handle into the locking rotational position in which the handle can be tilted in.

8. A closure for a vending machine, cabinet, or the like comprising:
a housing which can be secured in a movable thin wall;
an elongated rod or shaft being supported in the housing so as to be rotatable and axially displaceable in a limited manner by means of a handle;
wherein a free end of the rod has a sash-type fastener which is received at or in a rod receptacle or sash-type fastener receptacle formed by or carried by a stationary frame or wall in such a way that the rod can be freely slid axially in and out of the rod receptacle in a releasing rotational position, but is prevented from being slid out in a locking rotational position;
wherein the handle is supported in the housing so as to be tiltable around a bearing axis extending parallel to the plane of the movable wall and, at the same time, is supported in the housing so as to be rotatable around an axis extending perpendicular to the plane of the movable wall;
wherein a connection joint arm is arranged between supported ends of the handle and rod; and
wherein two articulation axes of the connection joint arm are arranged parallel to the bearing axis of the handle at a distance from one another such that the rod is displaced axially when the handle is tilted around the bearing axis of the handle.

9. The closure according to claim 8;
wherein the handle is supported in such a way that the two articulation axes and the bearing axis, each extending parallel to the wall, lie on a line.

10. The closure according to claim 9;
wherein the housing has a shape of a trough into which the handle can be tilted and locked in a dead center position of the handle in a tilted-in position.
